(19) United States
(12) Patent Application Publication
(10) Pub. No.: US 2018/0183791 A1
(43) Pub. Date: Jun. 28, 2018

(54) REMOTE COMMUNICATION SYSTEM, REMOTE COMMUNICATION METHOD, AND RECORDING MEDIUM

(71) Applicants: Takeshi HOMMA, Kanagawa (JP); Hideki SHIRO, Kanagawa (JP)

(72) Inventors: Takeshi HOMMA, Kanagawa (JP); Hideki SHIRO, Kanagawa (JP)

(21) Appl. No.: 15/837,005

(22) Filed: Dec. 11, 2017

(30) Foreign Application Priority Data
Dec. 22, 2016 (JP) 2016-249117

(51) Int. Cl. H04L 29/06; H04L 29/08

(52) U.S. Cl. CPC H04L 63/0876; H04L 67/18; H04L 65/1069

(57) ABSTRACT

A remote communication system authenticates each of a plurality of first communication terminals by using first authentication information of each of the plurality of first communication terminals, to establish a session between the plurality of first communication terminals; authenticates a second communication terminal by using second authentication information of the second communication terminal; transmits, to the second communication terminal, candidate pairing terminal information that indicates at least one candidate first communication terminal being capable of performing a pairing operation with the second communication terminal; accepts selection of a first communication terminal being selected as a target of the pairing operation; and performs the pairing operation between the selected first communication terminal and the second communication terminal, to enable the second communication terminal to join the session using resources of the selected first communication terminal.

### CROSS-REFERENCE TO RELATED APPLICATIONS

This patent application is based on and claims priority pursuant to 35 U.S.C. § 119(a) to Japanese Patent Application No. 2016-249117, filed on Dec. 22, 2016, in the Japan Patent Office, the entire disclosure of which is hereby incorporated by reference herein.

### BACKGROUND

### Technical Field

The present invention relates to a remote communication system, a remote communication method, and a recording medium.

### Description of the Related Art

With the development of network environments, remote communication, such as video conferences, is widely used. Further, with the advancement of information processing technology, various information processing apparatuses are used as client terminals for a remote communication system. In a case of conducting a video conference, for example, personal computers (PCs), smartphones, tablet terminals, and electronic whiteboards as well as dedicated terminals for a video conference are used as client terminals. Accordingly, users can select and use an apparatus that fits their preferences from among various information processing apparatuses to perform remote communication.

### SUMMARY

Example embodiments of the present invention include a system, a method, and a control program stored on a non-transitory recording medium, each of which: authenticates each of a plurality of first communication terminals by using first authentication information of each of the plurality of first communication terminals, to establish a session between the plurality of first communication terminals that have been authenticated to transmit or receive information through the session; authenticates a second communication terminal by using second authentication information of the second communication terminal, the second communication terminal to join the session using resources provided by the first communication terminal; transmits, to the second communication terminal, candidate pairing terminal information that indicates at least one candidate first communication terminal of the plurality of first communication terminals, the at least one candidate first communication terminal being capable of performing a pairing operation with the second communication terminal; accepts selection of a first communication terminal from among the plurality of first communication terminals, the first communication terminal being selected as a target of the pairing operation based on the candidate pairing terminal information; and performs the pairing operation between the selected first communication terminal and the second communication terminal, to enable the second communication terminal to join the session using resources of the selected first communication terminal.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overall network configuration of a remote communication system according to a first example of a first embodiment;

FIG. 2 is a diagram illustrating an overall network configuration of a remote communication system according to a second example of the first embodiment;

FIG. 3 is a diagram illustrating a hardware configuration of a dedicated terminal according to the first embodiment;

FIG. 4 is a diagram illustrating a hardware configuration of a communication management system, a Web server, a relay device, and a general-purpose terminal according to the first embodiment;

FIGS. 5A and 5B are a diagram illustrating a functional configuration of the remote communication system according to the second example of the first embodiment;

FIG. 6 is a diagram illustrating a functional configuration of the general-purpose terminal according to the first embodiment;

FIG. 7 is a diagram illustrating a functional configuration of the Web server according to the first embodiment;

FIG. 8 is a diagram illustrating a data structure of a dedicated-terminal table according to the first example of the first embodiment;

FIG. 9 is a diagram illustrating a data structure of a dedicated-terminal table according to the second example of the first embodiment;

FIG. 10 is a sequence chart illustrating a flow of a process performed in a remote communication system according to the first embodiment;

FIG. 11 is a diagram illustrating an ID input screen that is used in an authentication process for the general-purpose terminal according to the first embodiment to join a session;

FIG. 12 is a diagram illustrating a data structure of a terminal list request signal according to the first embodiment;

FIG. 13 is a diagram illustrating a candidate pairing terminal display screen according to the first example of the first embodiment;

FIG. 14 is a diagram illustrating a candidate pairing terminal display screen according to the second example of the first embodiment;

FIG. 15 is a diagram illustrating a data structure of a pairing request signal according to the first example of the first embodiment;

FIG. 16 is a diagram illustrating a data structure of a pairing request signal according to the second example of the first embodiment;

FIG. 17 is a diagram schematically illustrating features of the authentication process for the general-purpose terminal according to the first embodiment;

FIG. 18 is a diagram illustrating a display screen of the general-purpose terminal when a pairing operation according to the first embodiment is performed;

FIG. 19 is a diagram illustrating a display screen of the dedicated terminal when a pairing operation according to the first example of the first embodiment is performed;

FIG. 20 is a diagram illustrating a display screen of the dedicated terminal when a pairing operation according to the second example of the first embodiment is performed;

FIG. 21 is a diagram illustrating a functional configuration of a Web server according to a second embodiment;

FIG. 22 is a sequence chart illustrating a flow of a process performed in a remote communication system according to the second embodiment; and

FIG. 23 is a diagram schematically illustrating features of an authentication process for the general-purpose terminal according to the second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In a case of conducting a video conference using a remote communication system, various information processing apparatuses, such as PCs, smartphones, tablet terminals, and electronic whiteboards, as well as dedicated terminals for a video conference can be used as client terminals in the remote communication system. However, dedicated terminals used in only remote communication are different from general-purpose terminals used also for various purposes other than remote communication in, for example, quality (performance), ease of operation, or ease of use. Accordingly, in general, a user is unable to use a dedicated terminal and a general-purpose terminal in the same way.

Dedicated terminals generally have a special configuration for remote communication, and therefore, can provide, for example, high-quality video and audio to users when remote communication is performed. However, such dedicated terminals are usually used as shared terminals, and therefore, often have a configuration that basically assumes operations using keys and remote controllers so that anyone can easily use the terminals. Accordingly, such dedicated terminals may be inferior in, for example, ease of operation or ease of use to general-purpose terminals, such as PCs and smartphones, which a user is familiar with. On the other hand, general-purpose terminals are usually used personally, and therefore, for example, an operation unit of general-purpose terminals is personally customized and often provides, for example, superior ease of operation and use. However, in general, the quality of, for example, video and audio of general-purpose terminals in remote communication is lower than that of dedicated terminals.

In view of the above issues, the inventors have found a demand for realizing remote communication that utilizes the advantages of both dedicated terminals and general-purpose terminals.

Hereinafter, embodiments of a remote communication system, a method, and a medium will be described with reference to the attached drawings.

### First Embodiment

Overall Hardware Configuration of Remote Communication System

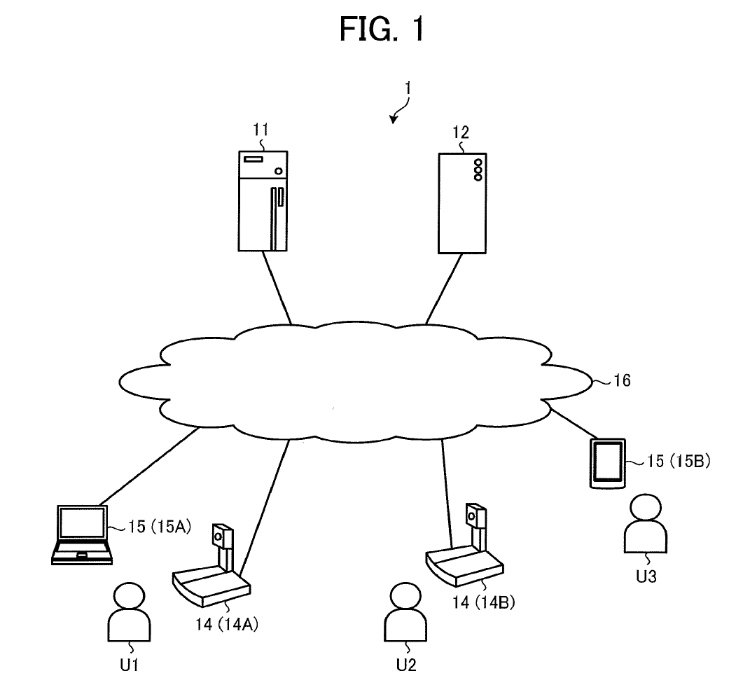

FIG. 1 is a diagram illustrating an overall network configuration of a remote communication system 1 according to a first example of a first embodiment. The remote communication system 1 according to this example includes a communication management system 11 (first system), a Web server 12 (second system), a dedicated terminal 14 (first communication terminal), a general-purpose terminal 15 (second communication terminal), and a communication network 16.

The communication management system 11 is an information processing system that performs a process for establishing a session, such as a video conference or an audio conference, in which information that includes at least sound is transmitted and received among a plurality of client terminals registered in advance. Client terminals according to this embodiment include the dedicated terminal 14 and the general-purpose terminal 15; however, the client terminals are not limited to the dedicated terminal 14 and the general-purpose terminal 15. The communication management system 11 can be formed by using, for example, a server computer; however, the hardware configuration of the communication management system 11 is not specifically limited.

The Web server 12 is a server computer that provides an application for performing a pairing operation between the dedicated terminal 14 and the general-purpose terminal 15. The pairing operation is an operation for the general-purpose terminal 15 to join a session, such as a video conference, by using resources of the dedicated terminal 14. The hardware configuration of the Web server 12 is not specifically limited.

The dedicated terminal 14 is a type of client terminal that joins a session established by the communication management system 11. The dedicated terminal 14 is an information processing apparatus dedicated to remote communication and having, for example, special functions and a special configuration for a specific session, such as a video conference. A plurality of dedicated terminals 14 placed at predetermined locations are individually connectable to the communication management system 11 via the communication network 16. The dedicated terminals 14 may be connectable to the Web server 12. The communication management system 11 has a function that enables a session to be established between the dedicated terminals 14. The state illustrated in FIG. 1 is an example state where the remote communication system 1 according to the first example includes two dedicated terminals 14, namely, a dedicated terminal 14A and a dedicated terminal 14B, the dedicated terminal 14A is used by a first user U1, and the dedicated terminal 14B is used by a second user U2. The number of the dedicated terminals 14 that join a session is not limited to two and may be three or more, as a matter of course.

The general-purpose terminal 15 is a type of client terminal that joins a session established by the communication management system 11. The general-purpose terminal 15 is an information processing apparatus that is used also for purposes other than the session and can be, for example, a PC, a smartphone, or a tablet terminal. A plurality of general-purpose terminals 15 placed at predetermined locations are individually connectable to the communication management system 11 and to the Web server 12 via the communication network 16. The communication management system 11 and the Web server 12 have functions that enable any of the general-purpose terminals 15 to join a session while performing a pairing operation with one of the dedicated terminals 14 (by using resources of the dedicated terminal 14). The general-purpose terminals 15 need not be directly connectable to the communication management system 11 and may be indirectly connectable to the communication management system 11 via the Web server 12 or another system. The state illustrated in FIG. 1 is an example state where the remote communication system 1 according to the first example includes two general-purpose terminals 15, namely, a general-purpose terminal 15A and a general-purpose terminal 15B, the general-purpose terminal 15A is used by the first user U1, and the general-purpose terminal 15B is used by a third user U3. The number of the general-purpose terminals 15 that join a session is not limited to two and may be three or more, as a matter of course.

The communication network 16 is a computer network that enables information to be transmitted and received among a plurality of information processing apparatuses, and is formed by using, for example, the Internet or a network compliant with the Ethernet (registered trademark) standard.

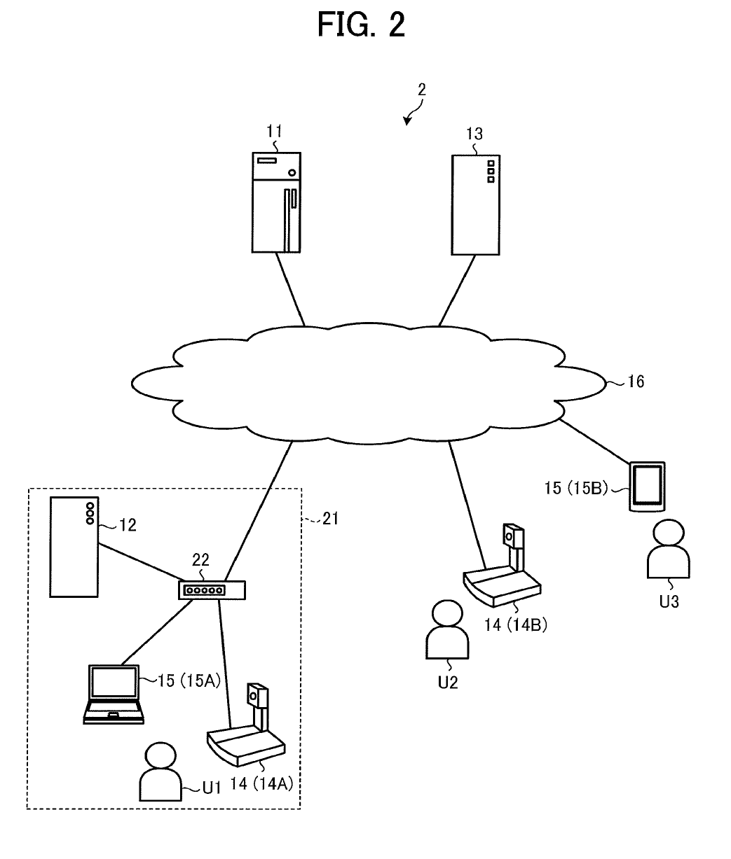

FIG. 2 is a diagram illustrating an overall network configuration of a remote communication system 2 according to a second example of the first embodiment. The remote communication system 2 according to this example includes the communication management system 11, the Web server 12, a relay device 13, the dedicated terminal 14, the general-purpose terminal 15, and the communication network 16.

The Web server 12 according to this example is included in a local area network (LAN) 21, which is, for example, an intra-company LAN that is built within a site in which the dedicated terminal 14 and the general-purpose terminal 15 used by the first user U1 are placed. The Web server 12 is connected to the communication network 16 via a router 22. As described above, the Web server 12 may be placed in the area of a system managed by a client (user U1).

The relay device 13 is a device that relays, for example, audio data and image data in remote communication (session) among a plurality of client terminals (for example, the dedicated terminal 14 and the general-purpose terminal 15). The relay device 13 can be formed of, for example, a server computer; however, the hardware configuration of the relay device 13 is not specifically limited. The communication management system 11 manages operations of the relay device 13. The relay device 13 need not be present and might not be used in a case where, for example, the scale of the remote communication system 2 is small. The relay device 13 need not have a separate hardware configuration and may be, for example, incorporated into the communication management system 11 as a functional unit.

Hardware Configuration of Dedicated Terminal

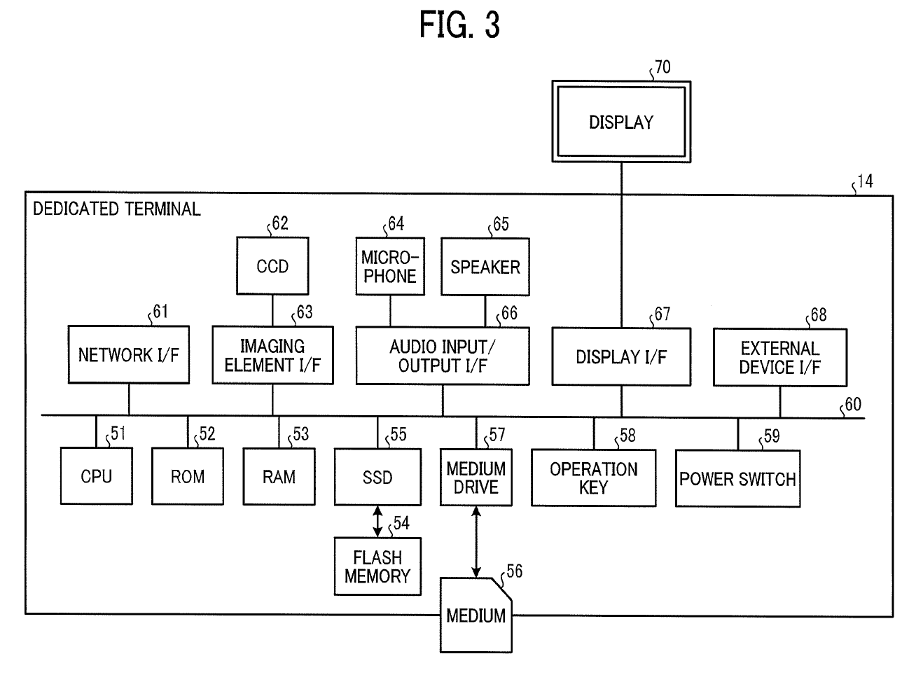

FIG. 3 is a diagram illustrating a hardware configuration of the dedicated terminal 14 according to the first embodiment. The dedicated terminal 14 includes a central processing unit (CPU) 51, a read-only memory (ROM) 52, a random access memory (RAM) 53, a flash memory 54, a solid state drive (SSD) 55, a medium drive 57, an operation key 58, a power switch 59, a network interface (I/F) 61, a charge coupled device (CCD) 62, an imaging element I/F 63, a microphone 64, a speaker 65, an audio input/output I/F 66, a display I/F 67, an external device I/F 68, and a bus line 60. The CPU 51 controls overall operations of the dedicated terminal 14. The ROM 52 stores a dedicated-terminal program. The RAM 53 is used as a work area of the CPU 51. The flash memory 54 stores various types of data including audio data and image data. The SSD 55 controls reading/writing of various types of data from/to the flash memory 54 in accordance with control by the CPU 51. The medium drive 57 controls reading/writing (storing) of data from/to (in) a medium 56, which is, for example, a flash memory. The operation key 58 is operated in a case of, for example, selecting a counterpart of the dedicated terminal 14. The power switch 59 is used to turn on/off the power of the dedicated terminal 14. The network I/F 61 is used to perform data transmission using the communication network 16. The CCD 62 is used to capture an image of a subject and obtain image data in accordance with control by the CPU 51. The imaging element IF 63 controls driving of the CCD 62. The microphone 64 receives sound. The speaker 65 outputs sound. The audio input/output I/F 66 performs input/output processing of audio signals between the microphone 64 and the speaker 65 in accordance with control by the CPU 51. The display I/F 67 is used to transmit image data to an external display 70 in accordance with control by the CPU 51. The external device IF 68 is used to transmit/receive various types of data to/from an external device. The bus line 60 functions as, for example, an address bus and a data bus for electrically connecting the above-described constituent elements with one another.

The recording medium 56 is attachable/detachable to/from the dedicated terminal 14. The recording medium 56 is not limited to a flash memory and may be any nonvolatile memory, such as an electrically erasable and programmable read-only memory (EEPROM), that enables data reading and writing in accordance with control by the CPU 51. The CCD 62 is a solid-state imaging device that converts light to electric charges to generate an electronic image (video) of a subject. The CCD 62 is not limited to a CCD and may be any device, such as a complementary metal oxide semiconductor (CMOS) device, used to capture an image of a subject. The display 70 is implemented by, for example, a liquid crystal display or an organic electroluminescence (EL) display that displays, for example, an image of a subject and icons for operations.

The dedicated-terminal program may be recorded to a computer-readable recording medium, such as the recording medium 56, as an installable file or an executable file and distributed.

Hardware Configuration of Communication Management System, Web Server, Relay Device, and General-Purpose Terminal

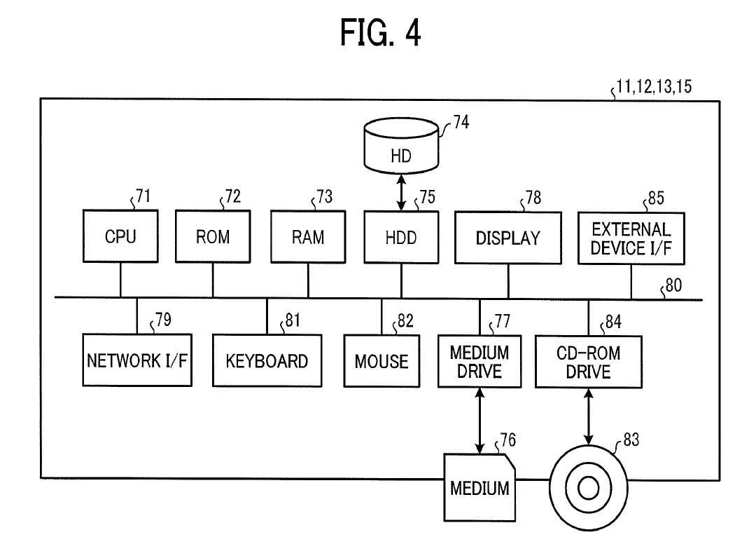

FIG. 4 is a diagram illustrating a hardware configuration of the communication management system 11, the Web server 12, the relay device 13, and the general-purpose terminal 15 according to the first embodiment. The communication management system 11, the Web server 12, the relay device 13, and the general-purpose terminal 15 can have the same hardware configuration. Here, an example case where the hardware configuration is used for the communication management system 11 is described.

The communication management system 11 includes a CPU 71, a ROM 72, a RAM 73, a hard disk (HD) 74, a hard disk drive (HDD) 75, a medium drive 77, a display 78, a network I/F 79, a keyboard 81, a mouse 82, a compact disc read-only memory (CD-ROM) drive 84, an external device I/F 85, and a bus line 80. The CPU 71 controls overall operations of the communication management system 11. The ROM 72 stores a communication management system program. The RAM 73 is used as a work area of the CPU 71. The HD 74 stores various types of data. The HDD 75 controls reading/writing of various types of data from/to the HD 74 in accordance with control by the CPU 71. The medium drive 77 controls reading/writing (storing) of data from/to (in) a medium 76, which is, for example, a flash memory. The display 78 displays various types of information, such as cursors, menus, windows, text, and images. The network I/F 79 is used to perform data transmission using the communication network 16. The keyboard 81 includes a plurality of keys that are used to input, for example, characters, numbers, and various instructions. The mouse 82 is used to, for example, select and carry out various instructions, select a processing target, and move a cursor. The CD-ROM drive 84 controls reading/writing of data from/to a CD-ROM 83, which is an example of an attachable/detachable recording medium. The external device I/F 85 is used to transmit/receive information to/from an external device. The bus line 80 functions as, for example, an address bus and a data bus for electrically connecting the above-described constituent elements with one another.

The above description is a description of an example application to the communication management system 11, and therefore, includes a description indicating that the communication management system program is stored in the ROM 72; however, a program stored in the ROM 72 changes in accordance with the use of the above-described hardware configuration, as a matter of course. That is, in a case where the hardware configuration is applied to the Web server 12, a Web server program is stored in the ROM 72. In a case where the hardware configuration is applied to the relay device 13, a relay device program is stored in the ROM 72. In a case where the hardware configuration is applied to the general-purpose terminal 15, a general-purpose terminal program is stored in the ROM 72.

The communication management system program, the Web server program, the relay device program, and the general-purpose terminal program may be recorded to a computer-readable recording medium, such as the medium 76 or the CD-ROM 83, as installable files or executable files and distributed. Examples of the attachable/detachable and computer-readable recording medium include a compact disc recordable (CD-R), a digital versatile disk (DVD), and a Blu-ray Disc.

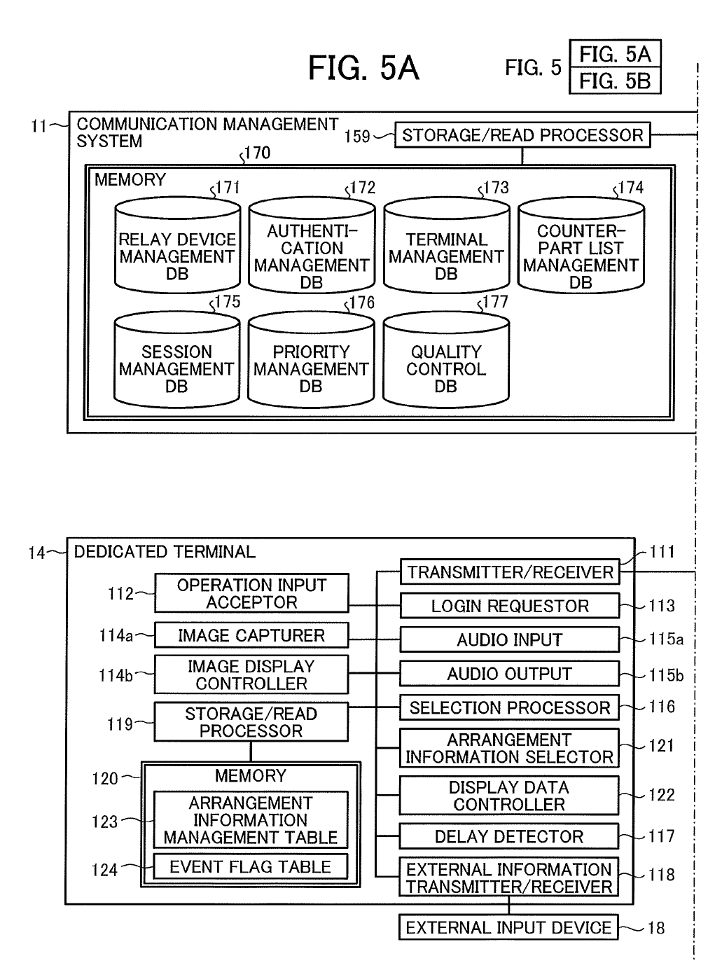

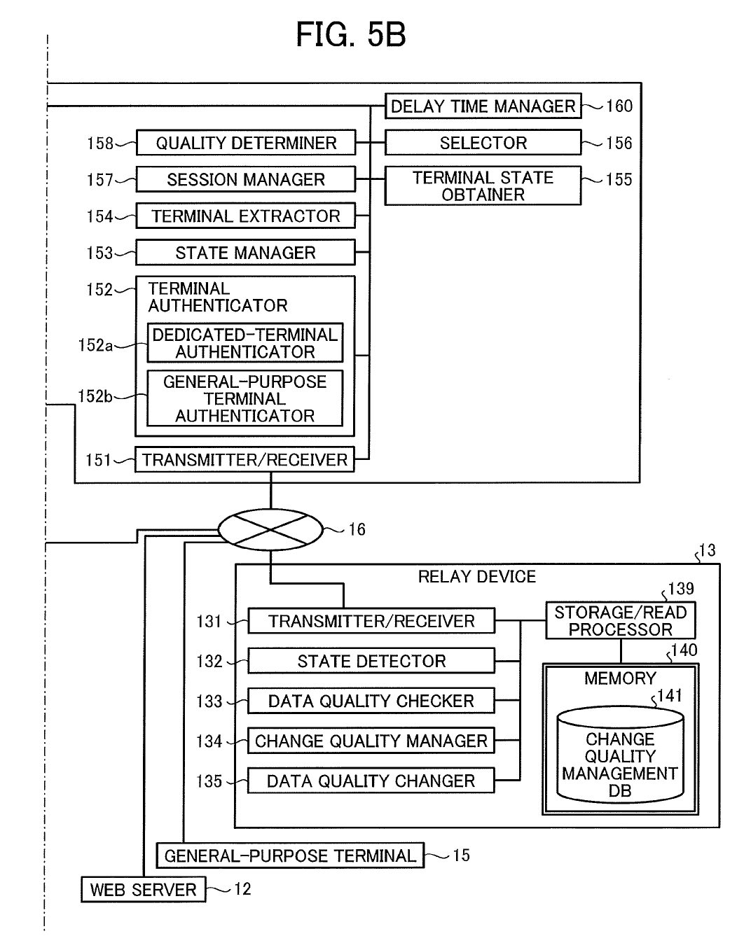

FIGS. 5A and 5B (FIG. 5) are a diagram illustrating a functional configuration of the remote communication system 2 according to the second example of the first embodiment. Here, for example, the remote communication system 2, which includes the relay device 13, according to the second example is described.

Functional Configuration of Dedicated Terminal

The dedicated terminal 14 includes a transmitter/receiver 111, an operation input acceptor 112, a login requestor 113, an image capturer 114a, an image display controller 114b, an audio input 115a, an audio output 115b, a selection processor 116, a delay detector 117, an external information transmitter/receiver 118, a storage/read processor 119, a memory 120, an arrangement information selector 121, and a display data controller 122. Each of these functional units is implemented by some of the constituent elements illustrated in FIG. 3 being operated in accordance with instructions given by the CPU 51 and based on the dedicated-terminal program stored in the ROM 52.

In a case where an external input device 18 is connected to the dedicated terminal 14, the external input device 18 obtains and transmits, to the dedicated terminal 14, display data. When receiving the display data, the dedicated terminal 14 transmits the display data to the relay device 13 via the communication network 16.

The memory 120 is implemented by the ROM 52, the RAM 53, or the flash memory 54. The memory 120 stores an arrangement information management table 123 and an event flag table 124.

The transmitter/receiver 111 is implemented as the network I/F 61 and transmits/receives various types of data (information) to/from other terminals, devices, or systems via the communication network 16.

The operation input acceptor 112 is implemented as input devices, such as the operation key 58 and the power switch 59, and accepts various types of input from the users U1 to U3. For example, when the user U1, U2, or U3 performs an operation of turning on the power switch 59, the operation input acceptor 112 generates a signal indicating that the operation of turning on the power has been performed.

The login requestor 113 is implemented in accordance with an instruction given by the CPU 51 and, upon acceptance of power ON described above, automatically transmits a login request signal for requesting a login (joining a session) and the current IP address of the dedicated terminal 14 to the communication management system 11 from the transmitter/receiver 111 via the communication network 16.

The image capturer 114a is implemented as the CCD 62 and the imaging element I/F 63. The image capturer 114a captures an image of a subject and generates image data. The image display controller 114b is implemented as the display IF 67 and performs control to transmit image data to the external display 70. The image display controller 114b displays image data generated by the image capturer 114a of the dedicated terminal 14, image data generated by the image capturer 114a of another dedicated terminal 14, and display data displayed on a display device of the external input device 18 and captured. The image display controller 114b has a function of controlling the display area of, for example, image data and display data.

The audio input 115a is implemented as the microphone 64 and the audio input/output I/F 66. The audio input 115a receives user's voice and converts the voice to an audio signal to thereby generate audio data of the audio signal. The audio output 115b is implemented as the speaker 65 and the audio input/output I/F 66. The audio output 115b converts generated audio data to sound and outputs the sound. The audio input 115a measures the input level of an audio signal and compares the input level with, for example, a threshold to determine the presence of the audio signal.

The arrangement information selector 121 selects a sharing flag from the event flag table 124 and sets the sharing flag in the arrangement information management table 123 in accordance with a distribution event of display data to thereby indicate, to the image display controller 114b, arrangement information about a screen to be displayed on the display 70.

The selection processor 116 performs a final selection process for finally selecting one relay device 13 from among a plurality of relay devices 13. The selection processor 116 records, each time preliminary transmission information is received by the transmitter/receiver 111, the reception date and time when the preliminary transmission information is received by the transmitter/receiver 111. The selection processor 116 calculates, for each piece of preliminary transmission information for which the reception date and time has been recorded, a time taken from transmission to reception of the piece of preliminary transmission information on the basis of the difference between the recorded reception date and time and a transmission date and time included in the piece of preliminary transmission information. The selection processor 116 selects the relay device 13 that relays a piece of preliminary transmission information for which the time taken is shortest among the times taken that are calculated by the selection processor 116 to thereby finally select one relay device 13.

The delay detector 117 is implemented in accordance with an instruction given by the CPU 51 and detects a delay time (ms) of image data or audio data transmitted from another dedicated terminal 14 via the relay device 13. The external information transmitter/receiver 118 is implemented as the external device I/F 68 and transmits/receives data to/from the external input device 18. The storage/read processor 119 is implemented as the SSD 55 and performs, for example, a process for storing various types of data in the memory 120 and a process for reading various types of data stored in the memory 120. The memory 120 stores, for example, a terminal ID for identifying the dedicated terminal 14, a password, a relay device ID for identifying the relay device 13, which transmits image data, audio data, and various types of data, and the IP address of a counterpart terminal.

The display data controller 122 obtains display data from the external input device 18 and transmits the obtained display data to the relay device 13. Examples of display data include image data obtained by forming an image displayed on the screen of a predetermined display device into, for example, the Joint Photographic Experts Group (JPEG) format or the bitmap format and data of drawing commands obtained by forming the image into, for example, the Graphics Device Interface (GDI) format. Examples of display data might include data of a material or might not include data of a material (and might be, for example, data of only a desktop screen). The display data controller 122 requests the relay device 13 to, for example, start distributing display data or stop distributing display data in accordance with a request from the external input device 18. The display data controller 122 refers to the event flag table 124 and determines the state of a display control flag in accordance with a distribution event from the relay device 13, and thereafter, transmits the display control flag to the external input device 18. The terminal ID and the relay device ID are pieces of identification information formed of, for example, languages, characters, symbols, or various marks and used to uniquely identify the dedicated terminal 14 and the relay device 13 respectively. The terminal ID and the relay device ID may be pieces of identification information formed by combining at least two types of information among languages, characters, symbols, and various marks.

Functional Configuration of Relay Device

The relay device 13 includes a transmitter/receiver 131, a state detector 132, a data quality checker 133, a change quality manager 134, a data quality changer 135, a storage/read processor 139, and a memory 140. Each of these functional units is implemented by some of the constituent elements illustrated in FIG. 4 being operated in accordance with instructions given by the CPU 71 and based on the relay device program stored in the ROM 72.

The memory 140 is implemented by the HD 74 and is a nonvolatile storage unit that keeps storing various types of data even after the power of the relay device 13 has been turned off. The memory 140 includes a change quality management database (DB) 141, which is implemented by a change quality management table. In the change quality management table, the IP address of each of the dedicated terminals 14 and a corresponding image quality of image data that is relayed by the relay device 13 are associated with each other and managed.

The transmitter/receiver 131 is implemented as the network I/F 79 and transmits/receives various types of data to/from other terminals, devices, or systems via the communication network 16. The state detector 132 is implemented in accordance with an instruction given by the CPU 71 and detects the operation state of the relay device 13 that includes the state detector 132. Examples of the operation state include an “online” state, an “offline” state, and an “out of order” state.

The data quality checker 133 is implemented in accordance with an instruction given by the CPU 71. The data quality checker 133 searches the change quality management table while using the IP address of a counterpart terminal as a search key and extracts a corresponding image quality of image data to thereby check the image quality of image data that is relayed. The change quality manager 134 is implemented in accordance with an instruction given by the CPU 71 and changes the content of the change quality management table in the change quality management DB 141 on the basis of quality information transmitted from the communication management system 11.

The data quality changer 135 is implemented in accordance with an instruction given by the CPU 71 and changes the image quality of image data transmitted from the dedicated terminal 14 that has transmitted the image data on the basis of the above-described changed content of the change quality management table in the change quality management DB 141. The storage/read processor 139 is implemented as the HDD 75 and performs, for example, a process for storing various types of data in the memory 140 and a process for reading various types of data stored in the memory 140.

Functional Configuration of Communication Management System

The communication management system 11 includes a transmitter/receiver 151, a terminal authenticator 152, a state manager 153, a terminal extractor 154, a terminal state obtainer 155, a selector 156, a session manager 157, a quality determiner 158, a storage/read processor 159, a delay time manager 160, and a memory 170. Each of these functional units is implemented by some of the constituent elements illustrated in FIG. 4 being operated in accordance with instructions given by the CPU 71 and based on the communication management system program stored in the ROM 72.

The memory 170 is implemented by the HD 74 and is a nonvolatile storage unit that keeps storing various types of data even after the power of the communication management system 11 has been turned off.

The memory 170 includes a relay device management DB 171, which is implemented by a relay device management table. In the relay device management table, for each relay device ID for identifying a corresponding relay device 13, state information indicating the operation state of the relay device 13, the reception date and time when the state information is received by the communication management system 11, the IP address of the relay device 13, and the maximum data transmission rate (Mbps) of the relay device 13 are associated with one another and managed.

The memory 170 includes an authentication management DB 172, which is implemented by an authentication management table. In the authentication management table, the terminal IDs of all client terminals (the dedicated terminals 14 and the general-purpose terminals 15) that join sessions managed by the communication management system 11 and the user IDs of all of the users U1 to U3, who use the client terminals 14 and 15, are associated with respective passwords and managed. The terminal Ds are pieces of information for identifying the client terminals 14 and 15, and the user IDs are pieces of information for identifying the users U1 to U3. The passwords are pieces of information that are used to authenticate the client terminals 14 and 15 or the users U1 to U3. Hereinafter, the terminal IDs and the user IDs may be collectively referred to as IDs. Each of the IDs is a piece of identification information formed of, for example, languages, characters, symbols, or various marks and used to uniquely identify a corresponding one of the client terminals 14 and 15 or a corresponding one of the users U1 to U3. Each of the IDs may be a piece of identification information formed by combining at least two types of information among languages, characters, symbols, and various marks. Each of the terminal IDs may include a piece of identification information used to identify a corresponding one of the users U1 to U3.

The memory 170 includes a terminal management DB 173, which is implemented by a terminal management table. In the terminal management table, for each of the terminal IDs of the client terminals 14 and 15 among the IDs, the terminal name, the operation state of the client terminal 14 or 15, the reception date and time when a login request signal is received by the communication management system 11, and the IP address of the client terminal 14 or 15 are associated with one another and managed. Examples of the operation state include an online state, which is a state where the power is turned on and communication is possible or communication is in progress, and an offline state, which is a state where communication is not possible because, for example, the power is not turned on. For example, in the terminal management table, for the dedicated terminal 14 having a terminal ID “10aa”, a terminal name “Japan Tokyo office AA terminal”, an operation state “online (communication is possible)”, the date and time when a login request signal is received by the remote communication system 1 “Nov. 10, 2009, 13:40”, and the IP address of the dedicated terminal 14 “1.2.1.3” are associated with one another and managed.

The memory 170 includes a counterpart list management DB 174, which is implemented by a counterpart list management table. In the counterpart list management table, the terminal ID of the client terminal 14 or 15 (start request terminal) that transmits start request information for a session is associated with the terminal ID of the client terminal 14 or 15 (candidate counterpart terminal) that is a candidate counterpart to which content is transmitted from the start request terminal or with the user ID of the user U1, U2, or U3 who uses the candidate counterpart terminal and managed. For example, the counterpart list management table indicates that candidate counterpart terminals to which the dedicated terminal 14 having the terminal ID “10aa” can make a request for starting a video conference are four dedicated terminals 14 having respective terminal IDs “10ab”, “10ac”, “10ad”, and “10ae”. Candidate counterpart terminals are updated in accordance with a request for addition or deletion made by a start request terminal to the communication management system 11.

The memory 170 includes a session management DB 175, which is implemented by a session management table. In the session management table, for each session ID for identifying a corresponding session in which content data is transmitted among the client terminals 14 and 15, the relay device ID of the relay device 13 that is used to relay the content data, the terminal ID of a start request terminal, the terminal ID of the client terminal 14 or 15 (counterpart terminal) that is specified by the start request terminal as a counterpart in the session, a reception delay time (ms) when image data is received by the counterpart terminal, and the reception date and time when delay information transmitted from the counterpart terminal and indicating the delay time is received by the communication management system 11 are associated with one another and managed.

The memory 170 includes a priority management DB 176, which is implemented by a priority management table. In the priority management table, an IP address and an address priority point, which is set in accordance with whether the four dotted address portions of a typical Internet Protocol version 4 (IPv4) IP address are the same as the four dotted address portions of the IP address, are associated with each other and managed. For example, in a case of an IP address in which the three higher-order dotted address portions have values the same as the values of the three higher-order dotted address portions of the IPv4 IP address, an address priority point of “5” is set. In a case of an IP address in which the two higher-order dotted address portions have values the same as the values of the two higher-order dotted address portions of the IPv4 IP address, an address priority point of “3” is set. In this case, whether the lowest-order dotted address portion has a value the same as the corresponding value in the IPv4 address does not affect the priority. In a case of an IP address in which the highest-order dotted address portion has a value the same as the value of the highest-order dotted address portion in the IPv4 IP address and in which the second highest-order dotted address portion has a value different from the value of the second highest-order dotted address portion in the IPv4 IP address, an address priority point of “1” is set. In this case, whether the third highest-order dotted address portion and the lowest-order dotted address portion have values the same as the corresponding values in the IPv4 IP address does not affect the priority. In a case of an IP address in which the highest-order dotted address portion has a value different from the value of the highest-order dotted address portion in the IPv4 IP address, an address priority point of “0” is set. In this case, whether the second, third, and lowest-order dotted address portions have values the same as the corresponding values in the IPv4 IP address does not affect the priority.

The memory 170 includes a quality control DB 177, which is implemented by a quality control table. In the quality control table, an image quality of image data that is relayed by the relay device 13, the image quality being set in accordance with a delay time (ms) of image data in a start request terminal or a counterpart terminal, is associated with the delay time and managed.

The transmitter/receiver 151 is implemented as the network I/F 79 and transmits/receives various types of data to/from other terminals, devices, or systems via the communication network 16.

The terminal authenticator 152 searches the authentication management table in the memory 170 while using a terminal ID or a user ID and a password included in a login request signal received via the transmitter/receiver 151 and determines whether the same ID and password are managed in the authentication management table to thereby authenticate the client terminal 14 or 15 or the users U1, U2, or U3.

The terminal authenticator 152 according to this embodiment includes a dedicated-terminal authenticator 152a (first authenticator) and a general-purpose terminal authenticator 152b (second authenticator). The dedicated-terminal authenticator 152a determines, on the basis of a terminal ID including a password (first authentication information), which is assigned to each dedicated terminal 14, whether the dedicated terminal 14 is allowed to join a session. The general-purpose terminal authenticator 152b determines, on the basis of a terminal ID including a password (second authentication information), which is assigned to each general-purpose terminal 15, whether the general-purpose terminal 15 is allowed to join a session.

The state manager 153 manages the operation states in the terminal management table. The state manager 153 manages the operation state of the client terminal 14 or 15 (login request terminal) that makes a login request. The state manager 153 manages the terminal ID of the login request terminal, the operation state of the login request terminal, the reception date and time when the login request signal is received by the communication management system 11, and the IP address of the login request terminal in association with one another in the terminal management table. On the basis of information transmitted from the client terminal 14 or 15 when the user U1, U2, or U3 turns on, for example, the power switch of the client terminal 14 or 15, the state manager 153 sets the operation state, which indicates “offline”, to “online” in the terminal management table. On the basis of information transmitted from the client terminal 14 or 15 when the user U1, U2, or U3 turns off, for example, the power switch of the client terminal 14 or 15, the state manager 153 sets the operation state, which indicates “online”, to “offline” in the terminal management table. When the transmitter/receiver 151 receives change request information from a start request terminal, which transmits start request information for a session, or from a counterpart terminal, the state manager 153 changes the operation state of at least one of the start request terminal and the counterpart terminal in the terminal management table in accordance with the change request information as appropriate.

The terminal extractor 154 searches the counterpart list management table while using an ID (for example, the terminal ID of a login request terminal or the user ID of the user U, U2, or U3 who makes a login request) as a search key and reads the terminal IDs of candidate counterpart terminals that are allowed to establish a session to thereby extract the terminal IDs. Specifically, the terminal extractor 154 reads, from the counterpart list management table, the terminal IDs of candidate counterpart terminals that are associated with the terminal ID of a start request terminal, the terminal ID of a start request terminal matching the ID that is a search key. Further, the terminal extractor 154 searches the counterpart list management table while using an ID as a search key and extracts the terminal IDs of the other client terminals 14 and 15 that register the ID that is a search key as a candidate counterpart terminal. Specifically, the terminal extractor 154 reads, from the counterpart list management table, the terminal IDs of start request terminals that are associated with the terminal ID of a candidate counterpart terminal, the terminal ID of a candidate counterpart terminal matching the ID that is a search key.

The terminal state obtainer 155 searches the terminal management table while using an ID as a search key and reads the operation state for the ID. Accordingly, the terminal state obtainer 155 can obtain the operation state of a candidate counterpart terminal that can establish a session with the client terminal 14 or 15 that makes a login request. Further, the terminal state obtainer 155 searches the terminal management table to obtain the operation state of the login request terminal.

The selector 156 finally selects one relay device 13 from among the plurality of relay devices 13. The selector 156 selects, from among the relay devices 13 managed in the relay device management table, the relay device ID of the relay device 13 that has an operation state set to “online” and that satisfies a predetermined condition (for example, the address priority managed in the priority management table satisfies a predetermined condition) to thereby select one relay device 13.

The session manager 157 stores and manages, in the session management table, a session ID, the terminal ID of a login request terminal, and the terminal ID of a counterpart terminal in association with one another. Further, the session manager 157 stores and manages, for each session ID in the session management table, the relay device ID of one relay device 13 that is finally selected.

The quality determiner 158 searches the quality control table while using a delay time as a search key and extracts a corresponding image quality of image data to thereby determine the image quality of image data that is relayed by the relay device 13.

The storage/read processor 159 is implemented as the HDD 75 and performs, for example, a process for storing various types of data in the memory 170 and a process for reading various types of data stored in the memory 170.

The delay time manager 160 searches the terminal management table while using the IP address of a counterpart terminal as a search key to thereby extract a corresponding terminal ID. The delay time manager 160 stores a delay time indicated by delay information in a delay time field in a record that includes the extracted terminal ID in the session management table to thereby manage the delay time.

Functional Configuration of General-Purpose Terminal

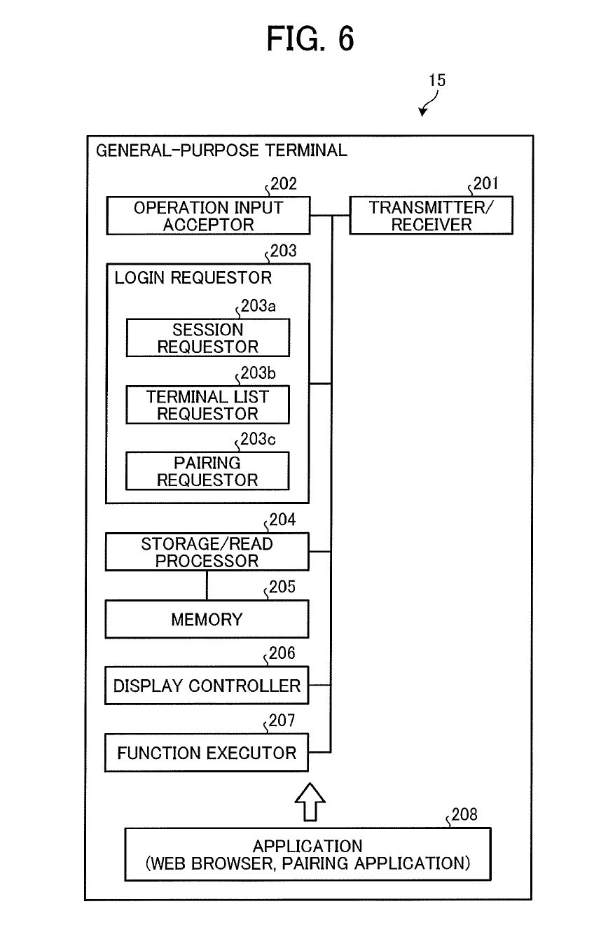

FIG. 6 is a diagram illustrating a functional configuration of the general-purpose terminal 15 according to the first embodiment. The general-purpose terminal 15 includes a transmitter/receiver 201, an operation input acceptor 202, a login requestor 203, a storage/read processor 204, a memory 205, a display controller 206, a function executor 207 (matching unit), and an application 208. Each of these functional units is implemented by some of the constituent elements illustrated in FIG. 4 being operated in accordance with instructions given by the CPU 71 and based on the general-purpose terminal program stored in the ROM 72.

The transmitter/receiver 201 is implemented as the network I/F 79 and transmits/receives various types of data to/from other terminals, devices, or systems via the communication network 16.

The operation input acceptor 202 is implemented as input devices, such as the keyboard 81, the mouse 82, and a touch panel, and accepts various types of input from the users U1 to U3. The operation input acceptor 202 generates a signal indicating the details of an operation performed by the user.

The login requestor 203 is implemented in accordance with an instruction given by the CPU 71 and includes a session requestor 203a, a terminal list requestor 203b (selection unit), and a pairing requestor 203c (matching unit).

The session requestor 203a is implemented in accordance with an instruction given by the CPU 71 and generates a session joining request signal for the general-purpose terminal 15 to request permission to join a session. In a case where an operation of requesting joining to a session is performed for the operation input acceptor 202, the session requestor 203a transmits a session joining request signal to the communication management system 11 (general-purpose terminal authenticator 152b) from the transmitter/receiver 201 via the communication network 16. The session joining request signal includes the ID of the general-purpose terminal 15, namely, the terminal ID or a user ID and a password (second authentication information). That is, in this embodiment, an authentication process for the general-purpose terminal 15 to join a session is performed between the general-purpose terminal 15 and the communication management system 11 by using the ID of the general-purpose terminal 15.

The terminal list requestor 203b is implemented in accordance with an instruction given by the CPU 71 and generates a terminal list request signal for requesting a terminal list (candidate pairing terminal information) indicating candidate dedicated terminals 14 that can perform a pairing operation with the general-purpose terminal 15. In a case where an operation of requesting a terminal list is performed for the operation input acceptor 202, the terminal list requestor 203b transmits a terminal list request signal to the Web server 12 from the transmitter/receiver 201 via the communication network 16. The terminal list request signal includes, for example, the ID of the general-purpose terminal 15 and an identifier (for example, a uniform resource identifier (URI)) that indicates the location of the general-purpose terminal 15 in the communication network 16.

The pairing requestor 203c is implemented in accordance with an instruction given by the CPU 71 and generates a pairing request signal for requesting a pairing operation with a specific dedicated terminal 14. As described above, a pairing operation is an operation in which the general-purpose terminal 15 joins a session by using resources of the dedicated terminal 14, in other words, an operation in which the general-purpose terminal 15 uses resources of the dedicated terminal 14 in a process related to the session. In a case where an operation of requesting a pairing operation (an operation of identifying the dedicated terminal 14 that is a counterpart in a pairing operation) is performed for the operation input acceptor 202, the pairing requestor 203c transmits a pairing request signal to the communication management system 11 from the transmitter/receiver 201 via the communication network 16. The pairing request signal includes, for example, the ID of the general-purpose terminal 15 that requests a pairing operation and the ID of the dedicated terminal 14 that is identified (selected) as a counterpart in the pairing operation.

The storage/read processor 204 is implemented as the HDD 75 in accordance with an instruction given by the CPU 71 and, for example, reads data stored in the memory 205 and writes data to the memory 205.

The memory 205 is implemented as the ROM 72, the RAM 73, and the HD 74 and stores various types of data, such as data for establishing a session, data for performing a pairing operation, and address book data. The address book data is data produced by the user U1, U2, or U3 who uses the general-purpose terminal 15 registering information about, for example, a contact. The address book data is created and retained by using a predetermined application.

The display controller 206 is implemented in accordance with an instruction given by the CPU 71 and controls screen display (for example, display of content in a session) on the display 78.

The function executor 207 is implemented in accordance with an instruction given by the CPU 71 and performs a predetermined process autonomously or in accordance with a request from another device. The function executor 207 according to this embodiment performs, for example, a process for performing a pairing operation with the dedicated terminal 14.

The application 208 is software for implementing the functions of the general-purpose terminal 15. The application 208 is installed and executed to thereby control the CPU 71. The application 208 includes a general-purpose Web browser and a pairing application 241 for performing a pairing operation. The transmitter/receiver 201, the operation input acceptor 202, the login requestor 203, the storage/read processor 204, the memory 205, the display controller 206, and the function executor 207 described above function via the application 208.

Functional Configuration of Web Server

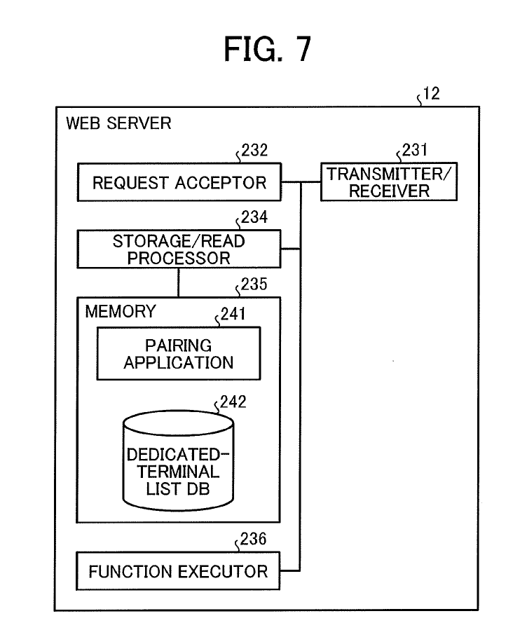

FIG. 7 is a diagram illustrating a functional configuration of the Web server 12 according to the first embodiment. The Web server 12 includes a transmitter/receiver 231, a request acceptor 232, a storage/read processor 234, a memory 235, and a function executor 236 (transmission unit). Each of these functional units is implemented by some of the constituent elements illustrated in FIG. 4 being operated in accordance with instructions given by the CPU 71 and based on the Web server program stored in the ROM 72.

The transmitter/receiver 231 is implemented as the network I/F 79 and transmits/receives various types of data to/from other terminals, devices, or systems via the communication network 16.

The request acceptor 232 is implemented in accordance with an instruction given by the CPU 71 and receives a terminal list request signal transmitted from the general-purpose terminal 15.

The storage/read processor 234 is implemented as the HDD 75 in accordance with an instruction given by the CPU 71 and, for example, reads data stored in the memory 235 and writes data to the memory 235.

The memory 235 is implemented as the ROM 72, the RAM 73, and the HD 74 and stores various types of data that is used to perform a pairing operation. The memory 235 stores the pairing application 241, which is used by the general-purpose terminal 15 to perform a process related to a pairing operation, and includes a dedicated-terminal list DB 242, which is implemented by a dedicated-terminal table. The pairing application 241 is provided (downloaded) to the general-purpose terminal 15 that requests a pairing operation. The dedicated-terminal table includes information in which general-purpose terminal information (second terminal information) about each general-purpose terminal 15 is associated with dedicated-terminal information (first terminal information) for identifying the dedicated terminal 14 that can perform a pairing operation with the general-purpose terminal 15.

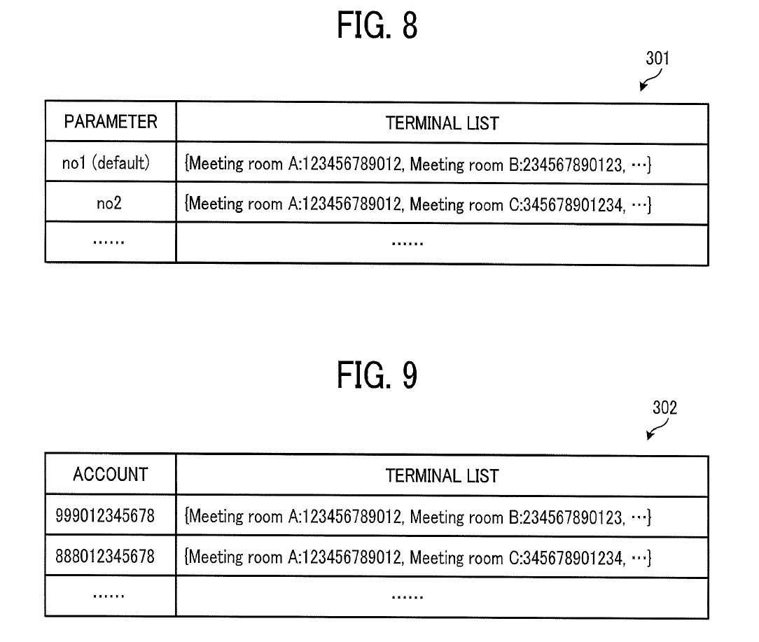

FIG. 8 is a diagram illustrating a data structure of a dedicated-terminal table 301 according to the first example of the first embodiment. The dedicated-terminal table 301 according to the first example includes parameters (no1, no2, . . . ), which serve as general-purpose terminal information, and terminal lists ({meeting room A: 123456789012, meeting room B: 234567890123, . . . }, {meeting room A: 123456789012, meeting room C: 345678901234, . . . }) (candidate pairing terminal information), which serve as dedicated-terminal information, in association with each other.

Each of the parameters is an identifier for identifying the location of a corresponding general-purpose terminal 15 in the communication network 16 and can be, for example, a URI or a uniform resource locator (URL). Each of the terminal lists is information for identifying one or more dedicated terminals 14 that can perform a pairing operation with the general-purpose terminal 15 that corresponds to a corresponding parameter. In the example illustrated in FIG. 8, each of the terminal lists includes a location where each dedicated terminal 14 is placed (for example, meeting room A) and an identification number (for example, a serial number, such as 123456789012) that is assigned to the dedicated terminal 14. When the identifier, such as the URI, of the general-purpose terminal 15 is used as a search key to search the dedicated-terminal table 301, a terminal list that indicates candidate dedicated terminals 14 that can perform a pairing operation with the general-purpose terminal 15 can be extracted.

FIG. 9 is a diagram illustrating a data structure of a dedicated-terminal table 302 according to the second example of the first embodiment. The dedicated-terminal table 302 according to the second example includes accounts (999012345678, 888012345678, . . . ), which serve as general-purpose terminal information, and terminal lists, which serve as dedicated-terminal information, in association with each other.

Each of the accounts is information formed of numbers, symbols, or a combination thereof that are assigned to a corresponding general-purpose terminal 15 and is information that corresponds to the ID of the general-purpose terminal 15. The terminal lists illustrated in FIG. 9 are the same as the terminal lists according to the first example illustrated in FIG. 8. When the account of the general-purpose terminal 15 is used as a search key to search the dedicated-terminal table 302, a terminal list that indicates candidate dedicated terminals 14 that can perform a pairing operation with the general-purpose terminal 15 can be extracted.

The function executor 236 is implemented in accordance with an instruction given by the CPU 71 and performs a predetermined process autonomously or in accordance with a request from another device. The function executor 236 according to this embodiment performs various processes for performing a pairing operation. The processes for performing a pairing operation include a process for providing the pairing application 241 to the general-purpose terminal 15 for performing a pairing operation and a process for transmitting a terminal list to the general-purpose terminal 15.

Operations of Remote Communication System

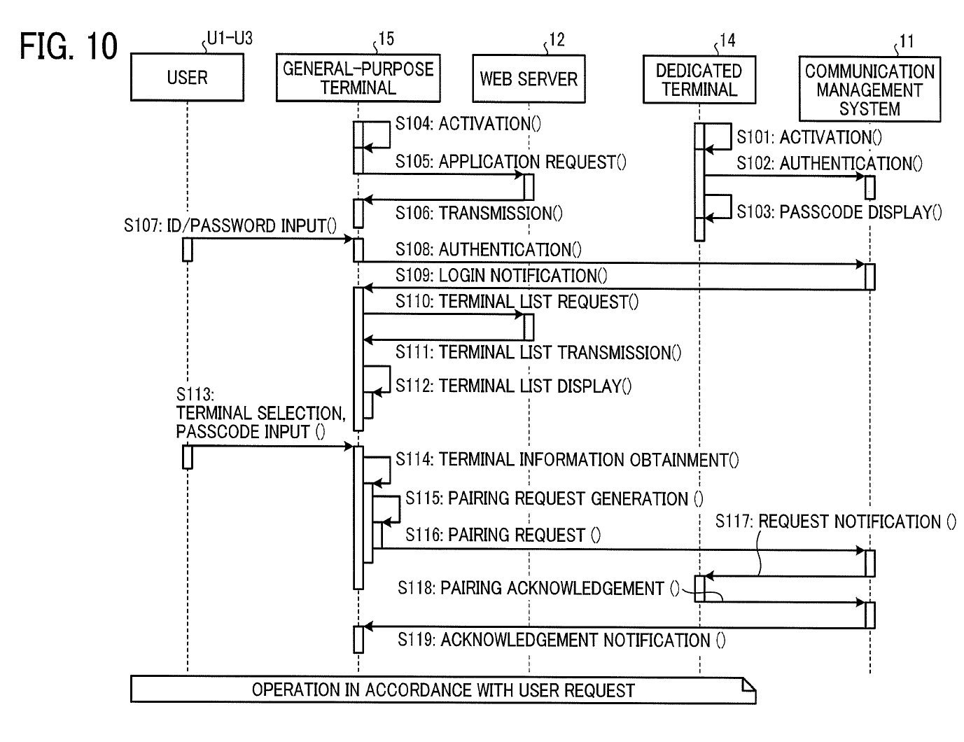

FIG. 10 is a sequence chart illustrating a flow of a process performed in the remote communication system 1 or 2 according to the first embodiment.

First, an authentication process (first authentication process) for the dedicated terminal 14 to join a session is performed. The dedicated terminal 14 is activated (step S101), and an authentication process for joining a session is performed between the dedicated terminal 14 and the communication management system 11 by using the ID (first authentication process) of the dedicated terminal 14 (step S102). When the authentication is successfully completed, a passcode is displayed on the display 70 of the dedicated terminal 14 or, for example, an external display connected to the dedicated terminal 14 (step S103).

Subsequently, a process for the general-purpose terminal 15 to obtain the pairing application 241 for performing a pairing operation is performed. When the general-purpose terminal 15 is activated (step S104) and requests the pairing application 241 (step S105), the Web server 12 transmits data of the pairing application 241 to the general-purpose terminal 15 (step S106).

Subsequently, an authentication process (second authentication process) for the general-purpose terminal 15 to join the session is performed. When the user U1, U2, or U3 inputs the ID, namely, the ID and a password (second authentication information), of the general-purpose terminal 15 to the operation input acceptor 202 of the general-purpose terminal 15 (step S107), an authentication process for joining the session is performed between the general-purpose terminal 15 and the communication management system 11 by using the ID of the general-purpose terminal 15 (step S108).

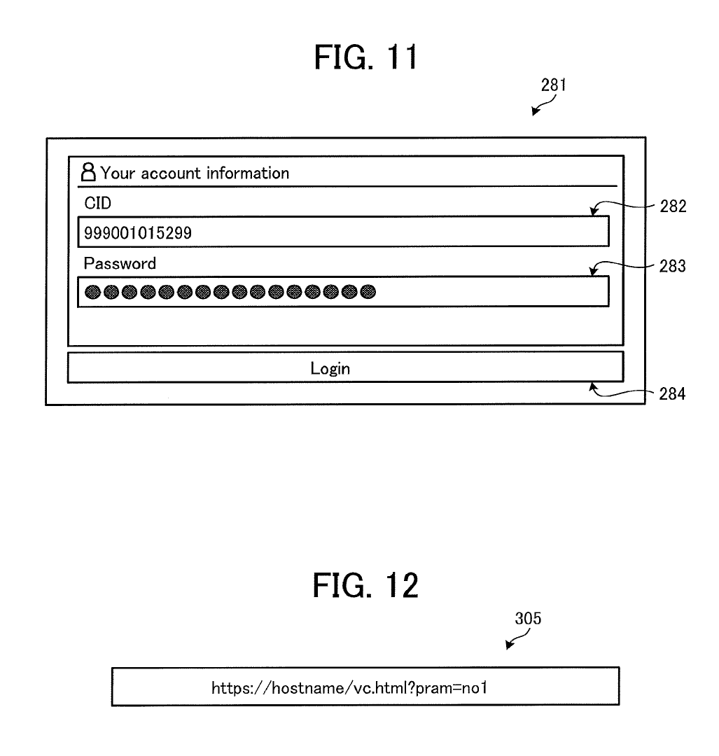

FIG. 11 is a diagram illustrating an ID input screen 281 that is used in the authentication process for the general-purpose terminal 15 according to the first embodiment to join a session. The ID input screen 281 includes a client ID input field 282, a password input field 283, and a login button 284. To the client ID input field 282, the terminal ID of the general-purpose terminal 15 that is to join the session or the user ID of the user U1, U2, or U3 who uses the general-purpose terminal 15 is input. To the password input field 283, a password that corresponds to the ID input to the client ID input field 282 is input. When an operation of pressing the login button 284 is performed after the client ID and the password have been input, general-purpose terminal information that includes the input client ID and password is transmitted from the general-purpose terminal 15 to the communication management system 11. When the authentication for the general-purpose terminal 15 to join the session is successfully completed, a login notification indicating that joining to the session is permitted is transmitted from the communication management system 11 to the general-purpose terminal 15 (step S109).

When receiving the login notification, the general-purpose terminal 15 transmits a terminal list request signal for requesting a terminal list that indicates candidate dedicated terminals 14 that can perform a pairing operation with the general-purpose terminal 15 (step S110). The terminal list request signal may be automatically transmitted in a case where the login notification is received or may be transmitted only in a case where the user U1, U2, or U3 performs a predetermined operation for the operation input acceptor 202. When receiving the terminal list request signal, the Web server 12 uses general-purpose terminal information (such as a URI or an account) included in the terminal list request signal as a search key, extracts a terminal list from the dedicated-terminal table 301 or 302, and transmits data of the terminal list to the general-purpose terminal 15 (step S111). When receiving the data of the terminal list, the general-purpose terminal 15 displays a candidate pairing terminal display screen that includes the terminal list (the list of dedicated terminals 14 that are candidate terminals for the pairing operation) on the display (step S112).

FIG. 12 is a diagram illustrating a data structure of a terminal list request signal 305 according to the first embodiment. The terminal list request signal 305 according to this example includes “pram=no1” for identifying the URI of the general-purpose terminal 15 that requests a pairing operation.

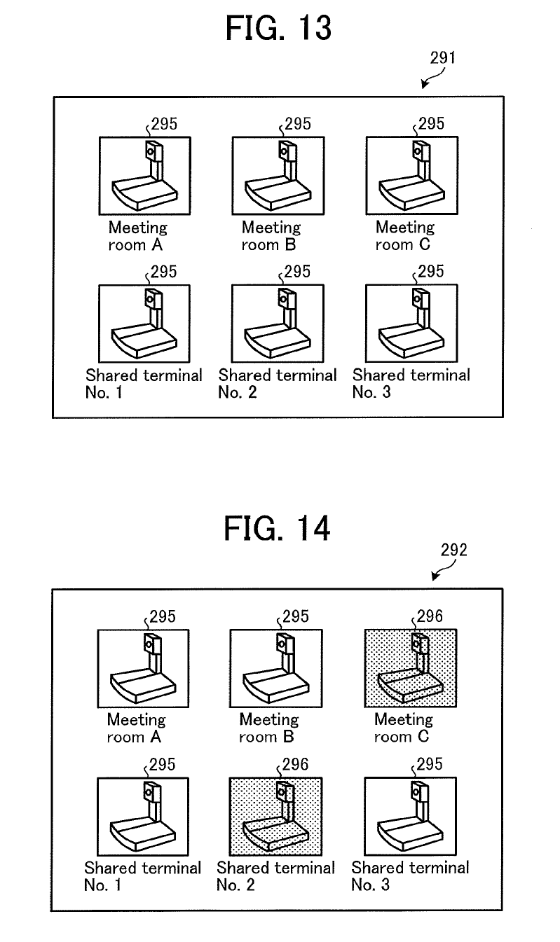

FIG. 13 is a diagram illustrating a candidate pairing terminal display screen 291 according to the first example of the first embodiment. On the candidate pairing terminal display screen 291, a plurality of icons 295 representing a plurality of dedicated terminals 14 that can perform a pairing operation with the general-purpose terminal 15 that has transmitted the terminal list request signal 305 are displayed.

FIG. 14 is a diagram illustrating a candidate pairing terminal display screen 292 according to the second example of the first embodiment. On the candidate pairing terminal display screen 292 according to the second example, icons 296 corresponding to the dedicated terminals 14 that are turned off are displayed in a manner different from the manner in which the icons 295 corresponding to the dedicated terminals 14 that are turned on are displayed. Accordingly, the users U1, U2, or U3 can recognize the dedicated terminal 14 that is currently turned off among the plurality of dedicated terminals 14 that can perform a pairing operation.

Subsequently, the user U1, U2, or U3 selects the dedicated terminal 14 that is to be a counterpart in the pairing operation from the terminal list (the candidate pairing terminal display screen 291 or 292) displayed on the general-purpose terminal 15, and inputs a passcode displayed on the selected dedicated terminal 14 (step S113). Subsequently, the general-purpose terminal 15 obtains information about the dedicated terminal 14 selected by the user (for example, the ID of the dedicated terminal 14) from information included in the terminal list (step S114), generates a pairing request signal for requesting a pairing operation with the selected dedicated terminal 14 (step S115), and transmits the pairing request signal to the communication management system 11 (step S116). The pairing request signal includes the ID of the dedicated terminal 14 selected as a counterpart in the pairing operation and the passcode input by the user U1, U2, or U3. Here, an example case where the passcode is input simultaneously with selection of the dedicated terminal 14 is described; however, the timing at which the passcode is input is not limited to this. For example, only selection of the dedicated terminal 14 may be made in step S113, and thereafter, the passcode may be input separately.

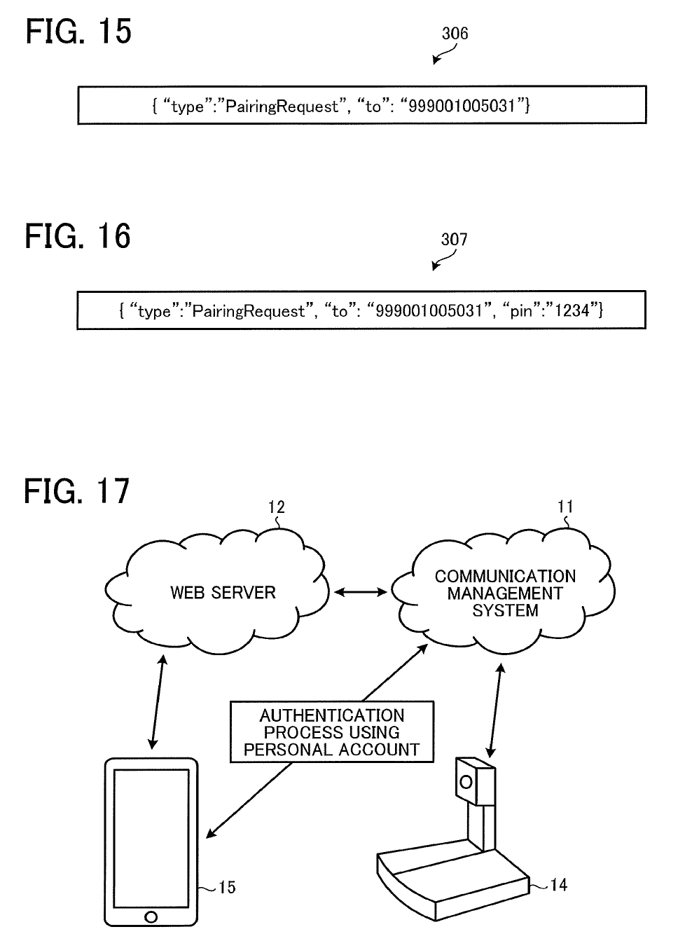

FIG. 15 is a diagram illustrating a data structure of a pairing request signal 306 according to the first example of the first embodiment. The pairing request signal 306 according to this example includes information indicating a request for a pairing operation (“type”: “PairingRequest”) and information for identifying the dedicated terminal 14 that is selected as a counterpart in the pairing operation (“to”: “999001005031”).

FIG. 16 is a diagram illustrating a data structure of a pairing request signal 307 according to the second example of the first embodiment. The pairing request signal 307 according to this example includes information indicating a request for a pairing operation (“type”: “PairingRequest”), information for identifying the dedicated terminal 14 that is selected as a counterpart in the pairing operation (“to”: “999001005031”), and information indicating the passcode input by the user U1, U2, or U3 (“pin”: “1234”).

Subsequently, when receiving the pairing request signal 306 or 307, the communication management system 11 transmits, to the dedicated terminal 14 selected as a counterpart in the pairing operation, a request notification signal indicating that a pairing operation request has been made (step S117). The request notification signal includes the ID of the general-purpose terminal 15 that has transmitted the pairing request signal 306 or 307 and the input passcode. When receiving the request notification signal, if a predetermined condition is satisfied, the dedicated terminal 14 transmits, to the communication management system 11, a pairing acknowledgement signal indicating that the pairing operation is permitted (step S118). The predetermined condition can be, for example, a condition that the passcode displayed on the dedicated terminal 14 matches the passcode input by the user U1, U2, or U3 or a condition that, according to the specifications of the dedicated terminal 14 and the specifications of the general-purpose terminal 15, the dedicated terminal 14 and the general-purpose terminal 15 can be paired with each other (have a specific application installed therein). When receiving the pairing acknowledgement signal, the communication management system 11 transmits, to the general-purpose terminal 15 that has transmitted the pairing request signal 306 or 307, an acknowledgement notification signal indicating that the pairing operation is acknowledged (step S119).

When receiving the acknowledgement notification signal, the general-purpose terminal 15 performs the pairing operation with the dedicated terminal 14 that has transmitted the pairing acknowledgement signal via the application 208 in accordance with a request made by the user U1, U2, or U3.

Features of Authentication Process for General-Purpose Terminal

FIG. 17 is a diagram schematically illustrating features of the authentication process for the general-purpose terminal 15 according to the first embodiment. As illustrated in FIG. 17 and steps S107 to S109 in FIG. 10, in the first embodiment, the authentication process for the general-purpose terminal 15 to join a session is performed between the general-purpose terminal 15 and the communication management system 11 by using an ID (personal account), which is set for each general-purpose terminal 15.

Address Book Pairing Function

In a pairing operation according to this embodiment, an address book pairing function is provided. The address book pairing function is related to address book data associated with the general-purpose terminal 15 or the dedicated terminal 14 and is a function of adding the other terminals or terminals used by the other users included in the address book data as targets of a pairing operation. The address book pairing function is implemented by using the functions of the application 208 (for example, the Web browser and the pairing application 241) installed in the general-purpose terminal 15 and the functions of, for example, an address book management application installed in the dedicated terminal 14. The address book data need not be stored in a specific location. The address book data may be stored in the memory 205 of the general-purpose terminal 15 or the memory 120 of the dedicated terminal 14 or may be stored in, for example, the memory 235 of the Web server 12 or a memory of another server.

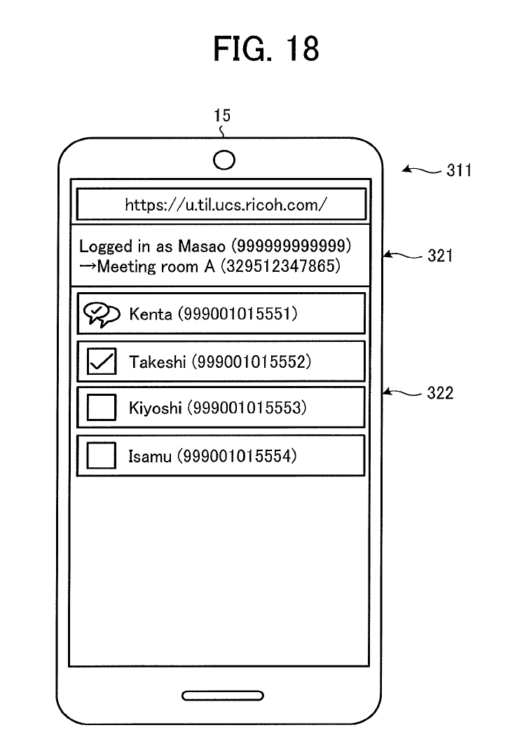

FIG. 18 is a diagram illustrating a display screen 311 of the general-purpose terminal 15 when a pairing operation according to the first embodiment is performed. The display screen 311 according to this example includes a paired counterpart terminal information display field 321 and an address book information display field 322. In the paired counterpart terminal information display field 321, information about the dedicated terminal 14 that is performing a pairing operation with the general-purpose terminal 15 is displayed. In this example, information for identifying the general-purpose terminal 15 (Masao (999999999999)) and information for identifying the dedicated terminal 14 that is a counterpart in the pairing operation (meeting room A (329512347865)) are displayed. In the address book information display field 322, information included in address book data associated with the general-purpose terminal 15 is displayed. In this example, information for identifying four users or terminals used by the users (Kenta (999001015551), Takeshi (999001015552), Kiyoshi (999001015553), and Isamu (999001015554)) is displayed. When the user U1, U2, or U3 who uses the general-purpose terminal 15 that is performing the pairing operation selects a desired terminal (user) from the list displayed in the address book information display field 322, the selected terminal can be added as a target of the pairing operation. This example illustrates a state where the general-purpose terminal 15 that corresponds to “Takeshi (999001015552)” is selected.

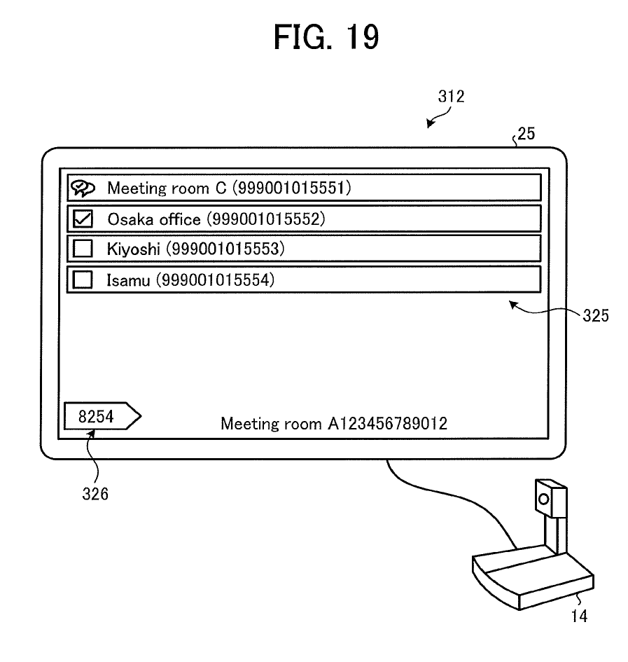

FIG. 19 is a diagram illustrating a display screen 312 of the dedicated terminal 14 when a pairing operation according to the first example of the first embodiment is performed. The display screen 312 according to this example includes an address book information display field 325 and a passcode display field 326. In the address book information display field 325, information included in address book data retained by the dedicated terminal 14 is displayed. In this example, information for identifying two dedicated terminals 14 (meeting room C (999001015551) and Osaka office (999001015552)) and information for identifying two users or terminals used by the users (Kiyoshi (999001015553) and Isamu (999001015554)) are displayed. When the user U1, U2, or U3 who uses the dedicated terminal 14 that is performing the pairing operation selects a desired terminal (user) from the list displayed in the address book information display field 325, the selected terminal can be added as a target of the pairing operation. This example illustrates a state where the dedicated terminal 14 that corresponds to “Osaka office (999001015552)” is selected. In the passcode display field 326, a passcode that is used in an authentication process for the pairing operation (for example, steps S103 and S113 in FIG. 10) is displayed. In this example, a four-digit number is displayed. When requesting pairing (step S113), the user U1, U2, or U3 inputs a passcode displayed on the display 70 connected to the dedicated terminal 14 to the general-purpose terminal 15. Then, an authentication process for the pairing operation is performed.

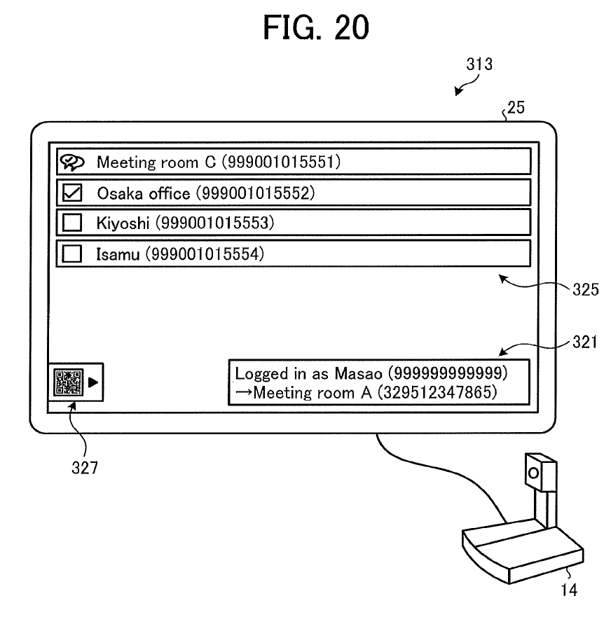

FIG. 20 is a diagram illustrating a display screen 313 of the dedicated terminal 14 when a pairing operation according to the second example of the first embodiment is performed. The display screen 313 according to this example includes the paired counterpart terminal information display field 321, the address book information display field 325, and a passcode display field 327. In the paired counterpart terminal information display field 321, information about the general-purpose terminal 15 that is performing a pairing operation with the dedicated terminal 14 is displayed. In this example, information for identifying the dedicated terminal 14 (meeting room A (329512347865)) and information for identifying the general-purpose terminal 15 (Masao (999999999999)) that is a counterpart in the pairing operation are displayed. The address book information display field 325 according to this example is similar to the address book information display field 325 according to the first example illustrated in FIG. 19. In the passcode display field 327 according to this example, a two-dimensional code is displayed as a passcode that is used in an authentication process for the pairing operation. When requesting pairing, the user U1, U2, or U3 reads an image of the two-dimensional code by using, for example, an image capturing function of the general-purpose terminal 15. Then, an authentication process for the pairing operation is performed in a similar manner as in the case of using the passcode according to the first example illustrated in FIG. 19.

In a case where at least some of the functions of the remote communication system 1 or 2 according to the above-described embodiment are implemented by executing a program, the program is written in advance to, for example, a ROM and provided. The program may be recorded to a computer-readable recording medium, such as a CD-ROM, a flexible disk (FD), a CD-R, or a DVD, as an installable file or an executable file and provided. The program may be stored on a computer that is connected to a network, such as the Internet, and provided by downloading the program via the network. The program may have a modular configuration that includes at least some of the above-described functions.

According to the above-described embodiment, when remote communication is performed, the users U1 to U3 can use resources of the dedicated terminals 14, which have an enhanced capability of processing content related to the remote communication, by operating the general-purpose terminal 15, which is superior in ease of operation and use. Accordingly, remote communication that utilizes the advantages of both the dedicated terminal 14 and the general-purpose terminal 15 can be realized.

### Second Embodiment

Hereinafter, a second embodiment will be described with reference to the drawings. In the second embodiment, a portion having the same function and effect or similar function and effect as those of a portion in the first embodiment is assigned the same reference numeral as that of the portion in the first embodiment, and a description thereof may be omitted.

Functional Configuration of Web Server

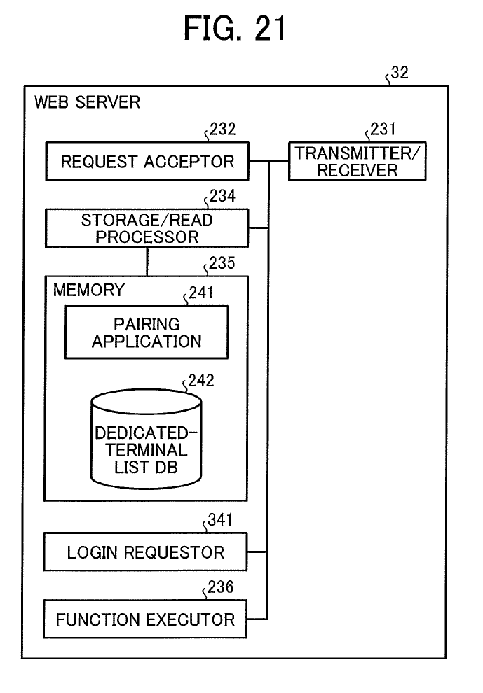

FIG. 21 is a diagram illustrating a functional configuration of a Web server 32 according to the second embodiment. The Web server 32 according to the second embodiment is different from the Web server 12 according to the first embodiment illustrated in FIG. 7 in that the Web server 32 includes a login requestor 341.

The login requestor 341 is a functional unit that performs, with the communication management system 11 on behalf of the general-purpose terminal 15, an authentication process for the general-purpose terminal 15 to join a session. The login requestor 341 is implemented in accordance with an instruction given by the CPU 71.

Operations of Remote Communication System

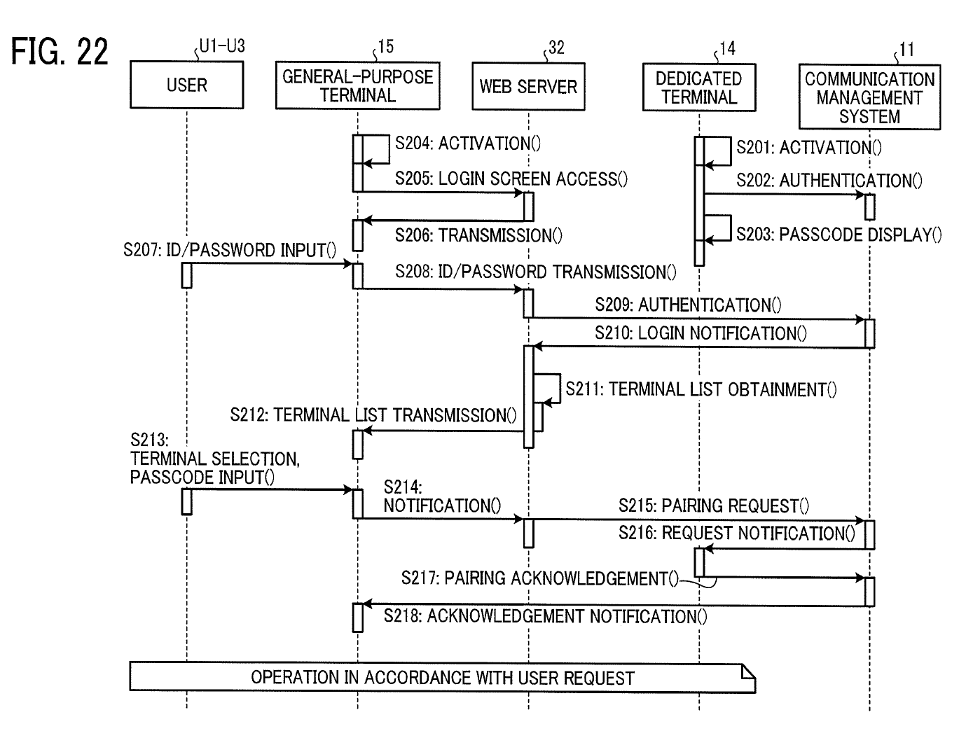

FIG. 22 is a sequence chart illustrating a flow of a process performed in the remote communication system 1 or 2 according to the second embodiment.

First, an authentication process (first authentication process) for the dedicated terminal 14 to join a session is performed. The dedicated terminal 14 is activated (step S201), and an authentication process for joining a session is performed between the dedicated terminal 14 and the communication management system 11 by using the ID (first authentication process) of the dedicated terminal 14 (step S202). When the authentication is successfully completed, a passcode is displayed on the display 70 of the dedicated terminal 14 or, for example, an external display connected to the dedicated terminal 14 (step S203).

Subsequently, a process for the general-purpose terminal 15 to obtain the pairing application 241 for performing a pairing operation is performed. When the general-purpose terminal 15 is activated (step S204), accesses a login screen for a login to the Web server 32 (step S205), and requests the pairing application 241, the Web server 32 transmits data of the pairing application 241 to the general-purpose terminal 15 (step S206).

Subsequently, an authentication process (second authentication process) for the general-purpose terminal 15 to join the session is performed. When the user U1, U2, or U3 inputs the ID, namely, the ID and a password (second authentication information), of the general-purpose terminal 15 to the operation input acceptor 202 (step S207), the general-purpose terminal 15 transmits the input ID of the general-purpose terminal 15 to the Web server 32 (step S208). Subsequently, the Web server 32 uses the received ID of the general-purpose terminal 15 to perform, with the communication management system 11, an authentication process for the general-purpose terminal 15 to join the session (step S209). When the authentication is successfully completed, a login notification indicating that joining to the session is permitted is transmitted from the communication management system 11 to the Web server 32 (step S210).

When receiving the login notification, the Web server 32 obtains a terminal list that indicates candidate dedicated terminals 14 that can perform a pairing operation with the general-purpose terminal 15 authenticated in step S209 (step S211), and transmits the terminal list to the general-purpose terminal 15 (step S212). The Web server 32 obtains a terminal list in step S211 by using the ID of the general-purpose terminal 15 received in step S208 as a search key and extracting a terminal list from the dedicated-terminal table 301 or 302 described above.

Subsequently, the user U1, U2, or U3 selects a desired dedicated terminal 14 from among the candidate dedicated terminals 14 that can perform a pairing operation displayed on the general-purpose terminal 15 that has received the terminal list, and inputs a passcode displayed on the selected dedicated terminal 14 (step S213). Subsequently, the general-purpose terminal 15 notifies the Web server 32 of the selected dedicated terminal 14 and the input passcode (step S214), and the Web server 32 transmits a pairing request signal for requesting a pairing operation with the selected dedicated terminal 14 to the communication management system 11 (step S215). The pairing request signal includes the ID of the dedicated terminal 14 selected as a counterpart in the pairing operation and the passcode input by the user U1, U2, or U3. Here, an example case where the passcode is input simultaneously with selection of the dedicated terminal 14 is described; however, the timing at which the passcode is input is not limited to this. For example, only selection of the dedicated terminal 14 may be made in step S213, and thereafter, the passcode may be input separately.

Subsequently, when receiving the pairing request signal from the Web server 32, the communication management system 11 transmits, to the dedicated terminal 14 selected as a counterpart in the pairing operation, a request notification signal indicating that a pairing operation request has been made (step S216). When receiving the request notification signal, if a predetermined condition is satisfied, the dedicated terminal 14 transmits, to the communication management system 11, a pairing acknowledgement signal indicating that the pairing operation is permitted (step S217). When receiving the pairing acknowledgement signal, the communication management system 11 transmits, to the general-purpose terminal 15 that has requested the pairing operation, an acknowledgement notification signal indicating that the pairing operation is acknowledged (step S218).

When receiving the acknowledgement notification signal, the general-purpose terminal 15 performs the pairing operation with the dedicated terminal 14 that has transmitted the pairing acknowledgement signal via the application 208 in accordance with a request made by the user U1, U2, or U3.

Features of Authentication Process for General-Purpose Terminal

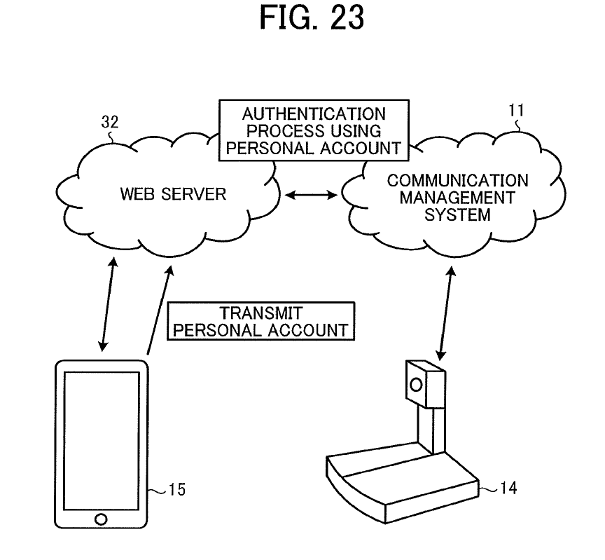

FIG. 23 is a diagram schematically illustrating features of the authentication process for the general-purpose terminal 15 according to the second embodiment. As illustrated in FIG. 23 and steps S207 to S210 in FIG. 22, in the second embodiment, the authentication process for the general-purpose terminal 15 to join a session is performed between the Web server 32 and the communication management system 11 by using an ID (personal account), which is set for each general-purpose terminal 15. Accordingly, for example, the processing load of the general-purpose terminal 15 can be reduced, and security can be increased.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A remote communication system comprising
circuitry configured to
authenticate each of a plurality of first communication terminals by using first authentication information of each of the plurality of first communication terminals, to establish a session between the plurality of first communication terminals that have been authenticated to transmit or receive information through the session;
authenticate a second communication terminal by using second authentication information of the second communication terminal, the second communication terminal to join the session using resources provided by the first communication terminal;
transmit, to the second communication terminal, candidate pairing terminal information that indicates at least one candidate first communication terminal of the plurality of first communication terminals, the at least one candidate first communication terminal being capable of performing a pairing operation with the second communication terminal;
accept selection of a first communication terminal from among the plurality of first communication terminals, the first communication terminal being selected as a target of the pairing operation based on the candidate pairing terminal information; and
perform the pairing operation between the selected first communication terminal and the second communication terminal, to enable the second communication terminal to join the session using resources of the selected first communication terminal.

2. The remote communication system according to claim 1, wherein
the candidate pairing terminal information causes a display of the second communication terminal to display information indicating the at least one candidate first communication terminal that is available for performing the pairing operation.

3. The remote communication system according to claim 1, further comprising
a memory configured to store the candidate pairing terminal information,
the candidate pairing terminal information associating second terminal information regarding the second communication terminal and first terminal information identifying the at least one candidate first communication terminal.

4. The remote communication system according to claim 3, wherein
the second terminal information is an identifier indicating a location of the second communication terminal on a network where the second communication terminal resides.

5. The remote communication system according to claim 3, wherein
the second terminal information is an account assigned to the second communication terminal.

6. The remote communication system according to claim 1, wherein
the circuitry includes
first circuitry configured to control the session between the plurality of first communication terminals; and
second circuitry configured to provide, to the second communication terminal, an application for performing the pairing operation,
the second circuitry is configured to obtain the second authentication information from the second communication terminal, and
the first circuitry is configured to receive the second authentication information from the second circuitry and use the second authentication information to authenticate the second communication terminal.

7. The remote communication system according to claim 1, wherein
in the pairing operation, the circuitry is configured to add other terminal identified by using address book data that is associated with at least one of the first communication terminal and the second communication terminal, which perform the pairing operation, as a target of the pairing operation.

8. The remote communication system according to claim 7, wherein
the other terminal is selected, as a target of the pairing operation, from a list indicating other candidate terminals that is displayed on at least one of a display of the first communication terminal and a display of the second communication terminal.

9. The remote communication system according to claim 1, further comprising:
the first communication terminal and the second communication terminal, which perform the pairing operation.

10. A remote communication method comprising:
authenticating each of a plurality of first communication terminals by using first authentication information of each of the plurality of first communication terminals, to establish a session between the plurality of first communication terminals that have been authenticated to transmit or receive information through the session;
authenticating a second communication terminal by using second authentication information of the second communication terminal, the second communication terminal to join the session using resources provided by the first communication terminal;
transmitting, to the second communication terminal, candidate pairing terminal information that indicates at least one candidate first communication terminal of the plurality of first communication terminals, the at least one candidate first communication terminal being capable of performing a pairing operation with the second communication terminal;
accepting selection of a first communication terminal from among the plurality of first communication terminals, the first communication terminal being selected as a target of the pairing operation based on the candidate pairing terminal information; and
performing the pairing operation between the selected first communication terminal and the second communication terminal, to enable the second communication terminal to join the session using resources of the selected first communication terminal.

11. A non-transitory recording medium which, when executed by one or more processors, cause the processors to perform a remote communication method comprising:
authenticating each of a plurality of first communication terminals by using first authentication information of each of the plurality of first communication terminals, to establish a session between the plurality of first communication terminals that have been authenticated to transmit or receive information through the session;
authenticating a second communication terminal by using second authentication information of the second communication terminal, the second communication terminal to join the session using resources provided by the first communication terminal;
transmitting, to the second communication terminal, candidate pairing terminal information that indicates at least one candidate first communication terminal of the plurality of first communication terminals, the at least one candidate first communication terminal being capable of performing a pairing operation with the second communication terminal;
accepting selection of a first communication terminal from among the plurality of first communication terminals, the first communication terminal being selected as a target of the pairing operation based on the candidate pairing terminal information; and
performing the pairing operation between the selected first communication terminal and the second communication terminal, to enable the second communication terminal to join the session using resources of the selected first communication terminal.
